(19) United States
(12) Patent Application Publication
(10) Pub. No.: US 2025/0158060 A1
(43) Pub. Date: May 15, 2025

(54) NEGATIVE ELECTRODE MATERIAL FOR LITHIUM ION SECONDARY BATTERY, METHOD OF PRODUCING NEGATIVE ELECTRODE MATERIAL FOR LITHIUM ION SECONDARY BATTERY, NEGATIVE ELECTRODE FOR LITHIUM ION SECONDARY BATTERY AND LITHIUM ION SECONDARY BATTERY

(71) Applicant: RESONAC CORPORATION, Tokyo (JP)

(72) Inventors: Akinobu OYA, Tokyo (JP); Kento HOSHI, Fukuoka (JP); Yu NAKAMURA, Tokyo (JP); Hidetoshi HOMBOH, Tokyo (JP)

(21) Appl. No.: 18/729,798

(22) PCT Filed: Jan. 18, 2022
(86) PCT No.: PCT/JP2022/001659

§ 371 Date: Jul. 17, 2024

(51) Int. Cl. H01M 4/587; C01B 32/21; H01M 4/02; H01M 4/36; H01M 10/0525

(52) U.S. Cl. CPC H01M 4/587; C01B 32/21; H01M 4/364; H01M 4/366; H01M 10/0525; C01P 2004/32; C01P 2004/50; C01P 2004/61; C01P 2006/12; C01P 2006/14; C01P 2006/40; H01M 2004/021; H01M 2004/027

(57) ABSTRACT

The negative electrode material for a lithium ion secondary battery contains at least one selected from the group consisting of the spherical natural graphite particle and the composite particle which are aggregates of the spherical natural graphite particles. The spherical natural graphite particles and the composite particles have an average particle diameter (D50) of 12 μm or less, and satisfy at least one of the following: (1) a linseed oil absorption of from 45 mL/100 g to 65 mL/100 g, or (2) composite particle having an integrated pore volume in a pore size range of from 0.003 μm to 90 μm of from 0.59 mL/g to 0.80 mL/g.

### TECHNICAL FIELD

The present invention relates to a negative electrode material for a lithium ion secondary battery, a method of producing negative electrode material for a lithium ion secondary battery, a negative electrode for a lithium ion secondary battery and a lithium ion secondary battery

### BACKGROUND ART

Lithium ion secondary batteries have been widely used in electronic devices such as notebook PCs, mobile phones, smartphones, and tablet PCs, taking advantage of their characteristics of small size, light weight, and high energy density. In recent years, against the backdrop of environmental issues such as global warming due to CO₂ emissions, clean electric vehicles (EVs) that run only on batteries and hybrid electric vehicles (HEVs) that combine a gasoline engine and batteries have become popular. Recently, lithium ion secondary batteries have also been used for power storage, and their applications are expanding in a wide range of fields.

In recent years, there has been a demand for lithium ion secondary batteries with excellent input characteristics in order to improve the efficiency of energy use. Lithium-ion secondary batteries are also required to have excellent life characteristics. However, in general, there is a trade-off between input characteristics and life characteristics, and it is necessary to improve both of them. In particular, in the application to the automotive field, which is one of the important applications, there is a high demand for improvements in both input characteristics and life characteristics.

For example, Patent Document 1 discloses the use of spherical natural graphite particles in which scale-like, flake or plate-like natural graphite particles are spheroidized and damaged by mechanical energy treatment, thereby improving the lithium ion input characteristics at the damaged portions. Furthermore, Patent Document 1 proposes providing amorphous carbon on the surfaces of spherical natural graphite particles to give them the properties of both graphite and amorphous carbon.

### RELATED ART DOCUMENTS

### Patent Documents

Patent Document 1: Japanese Patent Application Laid-Open (JP-A) No. 2000-340232

### SUMMARY OF INVENTION

However, lithium ion secondary batteries used in EVs, HEVs and the like require high input characteristics in order to be charged with the regenerative brake power. In addition, automobiles are easily affected by the outside temperature, and lithium ion secondary batteries are exposed to high temperatures, especially in the summer, and high life characteristics are required. High input characteristics and long life characteristics are also required in fields other than automobiles.

An object of one aspect of the present disclosure is to provide a negative electrode material for a lithium ion secondary battery that can be used to produce a lithium ion secondary battery with excellent input characteristics and life characteristics, a method of producing a negative electrode material for a lithium ion secondary battery, and a negative electrode for a lithium ion secondary battery.

Furthermore, an object of one aspect of the present disclosure is to provide a lithium ion secondary battery with excellent input characteristics and life characteristics.

### Solution to Problem

The present disclosure includes the following aspects.

<1> A negative electrode material for a lithium ion secondary battery, the negative electrode material containing at least one selected from the group consisting of a spherical natural graphite particle and a composite particle which is an aggregate of the spherical natural graphite particles,
in which the spherical natural graphite particle and the composite particle have an average particle diameter (D50) of 12 μm or less and a linseed oil absorption of from 45 mL/100 g to 65 mL/100 g.

<2> The negative electrode material for a lithium ion secondary battery according to <1>, in which the spherical natural graphite particle and the composite particle have an integrated pore volume in a pore size range of from 0.003 μm to 90 μm of from 0.59 mL/g to 0.80 mL/g.

<3> A negative electrode material for a lithium ion secondary battery, the negative electrode material including at least one selected from the group consisting of a spherical natural graphite particle and a composite particle which is aggregate of the spherical natural graphite particles,
in which the spherical natural graphite particle and the composite particle have an average particle diameter (D50) of 12 μm or less and an integrated pore volume in a pore size range of from 0.003 μm to 90 μm of from 0.59 mL/g to 0.80 mL/g.

<4> A negative electrode material for a lithium ion secondary battery according to any one of <1> to <3>, in which the spherical natural graphite particle and the composite particle have an average particle diameter (D50) of 12 μm or less and an integrated pore volume in a pore size range of 2 nm or less of from 1.15×10⁻³ cm³/g to 1.40×10⁻³ cm³/g.

<5> The negative electrode material for a lithium ion secondary battery according to any one of <1> to <4>, in which at least a portion of a surface of the spherical natural graphite particle and the composite particle is coated with a carbon material.

6> A method of producing a negative electrode material for a lithium ion secondary battery, the method including:
preparing a rubber mold that contains graphite particles; and
dry-pressuring the rubber mold from the outside isotropically.

<7> The method of producing a negative electrode material for lithium ion secondary battery according to <6>, the method further including heat-treating a mixture containing the graphite particles after the dry-pressuring and a carbon material precursor.

<8> The method of producing a negative electrode material for a lithium ion secondary battery according to <6> or <7>, in which the negative electrode material is the negative electrode material for a lithium ion secondary battery according to any one of <1> to <5>.

<9> A negative electrode for a lithium ion secondary battery, the negative electrode containing a negative electrode material layer containing the negative electrode material for a lithium ion secondary battery according to any one of <1> to <5>, and a current collector.

<10> A lithium ion secondary battery containing the negative electrode for a lithium ion secondary battery according to <9>, a positive electrode, and an electrolyte.

### Advantageous Effects of Invention

In one aspect of the present disclosure, it is possible to provide a negative electrode material for lithium ion secondary battery, a method of producing a negative electrode material for lithium ion secondary battery, and a negative electrode for lithium ion secondary battery, which are capable of producing a lithium ion secondary battery with excellent input characteristics and life characteristics.

Furthermore, in one aspect of the present disclosure, it is possible to provide a lithium ion secondary battery with excellent input characteristics and life characteristics.

### BRIEF DESCRIPTION OF DRAWINGS

FIG. 1 is an electron microscope photograph of a cross section of a negative electrode material obtained by a method of producing in the present disclosure.

### DESCRIPTION OF EMBODIMENTS

Embodiments in the present disclosure will be described in detail. It is to be noted, however, that the present disclosure is not limited to the following embodiments. In the embodiments described below, components thereof (including element steps and the like) are not essential, unless otherwise specified. The same applies to numerical values and their ranges, and the present disclosure is not limited thereto.

In this disclosure, the term “process” includes not only a process that is independent from other processes, but also a process that cannot be clearly distinguished from other processes, as long as the purpose of the process is achieved.

In the present disclosure, any numerical range indicated using an expression “to” includes numerical values described before and after “to” as a minimum value and a maximum value, respectively.

In a numerical range described in stepwise, in the present disclosure, the upper limit value or the lower limit value described in one numerical range may be replaced with the upper limit value or the lower limit value in another numerical range described in stepwise. Further, in a numerical range described in the present disclosure, the upper limit value or the lower limit value described in the numerical range may be replaced with a value shown in Examples.

In the present disclosure, each component in a negative electrode material and composition may contain a plurality of corresponding substances. In a case in which plural kinds of substances corresponding to a certain component are present in the negative electrode material and composition, the content means, unless otherwise specified, a total amount of the plural kinds of substances present in the negative electrode material and composition.

In the present disclosure, the term “layer” comprehends herein not only a case in which the layer is formed over the whole observed region where the layer is present, but also a case in which the layer is formed only on part of the region.

In this disclosure, the term “layered” refers to a stack of layers, where two or more layers may be bonded to one another or two or more layers may be removable.

In the present disclosure, a spherical natural graphite particle refers to a graphite particle obtained by a scale-like, flake or plate-like natural graphite particle being spheroidized by mechanical energy treatment. The spherical natural graphite particle does not have to be perfectly spherical.

In the present disclosure, an average particle diameter (D50) is a particle size at which a cumulative volume distribution curve reaches 50% of a total when plotting from the small diameter side in a particle size distribution measured by a laser diffraction particle size distribution measuring device. An example of a laser diffraction particle size distribution measuring device includes SALD-3000J manufactured by Shimadzu Corporation.

In the present disclosure, linseed oil absorption is measured according to the method described in JIS K6217-4:2008 “Carbon black for rubber industry-Fundamental characteristics-Part 4: Determination of oil absorption number”, except that linseed oil (manufactured by Kanto Chemical Co., INC.) is used as the reagent liquid instead of dibutyl phthalate (DBP).

A specific method for measuring linseed oil absorption is as follows: linseed oil is titrated into a measurement sample using a constant speed burette, and a change in viscosity characteristics is measured using a torque detector. An amount of reagent liquid added per unit mass of the measurement sample that corresponds to 70% of the maximum torque generated is defined as the linseed oil absorption (mL/100 g). An example of a measuring device is an absorption measuring device from ASAHI SOUKEN CORPORATION.

In the present disclosure, an integrated pore volume in a pore range of from 0.003 μm to 90 μm (hereinafter also referred to as “macropore volume”) is a value measured by a mercury intrusion method using a mercury porosimeter. An example of the mercury porosimeter is Autopore IV 9500 manufactured by Shimadzu Corporation.

A specific method for measuring the macropore volume is as follows. A measurement sample is sealed in a cell for a powder and pretreated by degassing for 5 minutes at room temperature (25° C.) under vacuum (50 μmHg or less). After reducing the pressure to 2.00 psia (approximately 14 kPa) and introducing mercury, the pressure is increased in steps to 60,000 psia (approximately 410 MPa) and then decreased to 0.10 psia (approximately 0.69 kPa). A number of steps during pressure increase is 81 or more, and after a 5-second equilibration period at each step, an amount of mercury intrusion is measured. A pore distribution is obtained from the obtained mercury intrusion curve using in the Washburn equation, and an integrated pore volume in a pore range of from 0.003 μm to 90 μm is calculated. A conditions for the mercury porosimeter measurement are as follows:
Mercury intrusion pressure: 2.00 psia (approximately 14 kPa)
Pressure holding time at each measurement pressure: 5 seconds
Contact angle between sample and mercury: 130° Surface tension of mercury: 485 dynes/cm (4.85×10⁻³ N/cm)
Density of mercury: 13.5335 g/mL

In the present disclosure, an integrated pore volume in a pore range of 2 nm or less (hereinafter also referred to as “micropore volume”) is a value measured using nitrogen gas adsorption method. The micropore volume can be measured, for example, using a high-performance specific surface area/pore distribution measurement device (ASAP2020, manufactured by Micromeritics Instrument Corporation).

A specific method for measuring the micropore volume is as follows. A measurement sample is sealed in a cell for a powder and pretreated by placing it at 200° C. under vacuum (7 μmHg or less) for 10 hours, and then a adsorption isotherm (adsorbed gas: nitrogen) is measured at liquid nitrogen temperature with a relative pressure P/P₀ of from 0.00001 to 1.0 (P=equilibrium pressure, P0=saturated vapor pressure). The obtained adsorption isotherm is used to obtain a micropore distribution by SF analysis, and the integrated pore volume in a pore range of 2 nm or less is calculated.

### <Negative Electrode Material for Lithium Ion Secondary Battery>

A negative electrode material for a lithium ion secondary battery in the first embodiment includes at least one selected from the group consisting of a spherical natural graphite particle and a composite particle which is an aggregate of the spherical natural graphite particles, in which the spherical natural graphite particle and the composite particle have an average particle diameter (D50) of 12 μm or less and a linseed oil absorption of from 45 mL/100 g to 65 mL/100 g.

A negative electrode material for a lithium ion secondary battery in the second embodiment includes at least one selected from the group consisting of a spherical natural graphite particle and a composite particle which is aggregate of the spherical natural graphite particles, in which the spherical natural graphite particle and the composite particle have an average particle diameter (D50) of 12 μm or less and an integrated pore volume in a pore size range of from 0.003 μm to 90 μm of from 0.59 mL/g to 0.80 mL/g.

The spherical natural graphite particle and the composite particle in the first embodiment may have integrated pore volume in a pore size range of from 0.003 μm to 90 μm of from 0.59 mL/g to 0.80 mL/g. The spherical natural graphite particle and the composite particle in the second embodiment may have a linseed oil absorption of from 45 mL/100 g to 65 mL/100 g. The spherical natural graphite particle and the composite particle in the first and second embodiments may have an integrated pore volume in a pore size range of 2 nm or less of from 1.15×10⁻³ cm³/g to 1.40×10⁻³ cm³/g.

A total content of the spherical natural graphite particle and the composite particle in the negative electrode material for a lithium ion secondary battery (hereinafter also simply referred to as the “negative electrode material”) is not particularly limited, and is preferably 50% by mass or more, more preferably 80% by mass or more, even more preferably 90% by mass or more, and particularly preferably 100% by mass.

The negative electrode material may contain other carbon material other than the spherical natural graphite particle and the composite particle. The other carbon material is not particularly limited, and examples thereof include a scale-like, flake or plate-like natural graphite, which have not been spheronized, an artificial graphite, an amorphous carbon, a carbon black, a fibrous carbon, and a nanocarbon. The other carbon material may be used singly, or in a combination of two or more kinds thereof.

The negative electrode material may contain a particle containing an element other than the carbon material, the element that can store and release lithium ions. The element that can store and release lithium ions is not particularly limited, and examples thereof include Si, Sn, Ge, In, and the like.

An average particle diameter (D50) of the spherical natural graphite particle and the composite particle in the first and second embodiments is 12 μm or less. In order to prevent the diffusion distance of lithium from a surface to the inside of the negative electrode material from becoming too long and to further improve the input characteristics of the lithium ion secondary battery, the average particle diameter (D50) of the spherical natural graphite particle and the composite particle is preferably 10 μm or less, more preferably 9.5 μm or less, even more preferably 9.0 μm or less, and particularly preferably 8.8 μm or less. The average particle diameter (D50) of the spherical natural graphite particle and the composite particle is preferably 5 μm or more, and may be 7 μm or more, or may be 8.5 μm or more. In a case in which the average particle diameter (D50) of the spherical natural graphite particle and the composite particle is 5 μm or more, the pressing pressure required to form the negative electrode material layer may be reduced, and as a result, a lithium ion secondary battery having more excellent input characteristics tends to be produced.

The negative electrode material contains at least one selected from the group consisting of the spherical natural graphite particle and the composite particle. Therefore, the negative electrode material may contain only one of the spherical natural graphite particle or the composite particle, or may contain both the spherical natural graphite particle and the composite particle.

In the present disclosure, the physical properties of the spherical natural graphite particle and the composite particle mean the physical properties of the spherical natural graphite particles or the physical properties of the composite particles in a case in which the negative electrode material contains only one of the spherical natural graphite particle or the composite particle, and mean the physical properties of the spherical natural graphite particle and the composite particle as a whole in a case in which the negative electrode material contains both the spherical natural graphite particle and the composite particle.

For example, “average particle diameter (D50) of the spherical natural graphite particle and the composite particle” means an average particle diameter (D50) of the spherical natural graphite particle in a case in which the negative electrode material contains only the spherical natural graphite particle among the spherical natural graphite particle and the composite particle, means an average particle diameter (D50) of composite particles in a case in which the negative electrode material contains only the composite particle among the spherical natural graphite particle and the composite particle, and means an average particle diameter (D50) of the spherical natural graphite particle and the composite particle as a whole in a case in which the negative electrode material contains both the spherical natural graphite particle and the composite particle.

The composite particle is an aggregate of the spherical natural graphite particles. The composite particle may contain 2 to 6 spherical natural graphite particles, or may contain 3 to 5 spherical natural graphite particles. A method for producing the negative electrode material containing the composite particle is not particularly limited and may be either a mechanical method or a chemical method, and is preferably a method for producing the negative electrode material for a lithium ion secondary battery disclosed below. In the composite particle composited by the method for producing a negative electrode material for a lithium ion secondary battery according to the present disclosure, the spherical natural graphite particle is directly composited together without the intervention of a binder or the like.

### First Embodiment

The negative electrode material in the first embodiment includes at least one selected from the group consisting of the spherical natural graphite particle and the composite particle which is an aggregate of the spherical natural graphite particle, in which the spherical natural graphite particle and the composite particle have an average particle diameter (D50) of 12 μm or less and a linseed oil absorption of from 45 mL/100 g to 65 mL/100 g.

In a case in which the negative electrode material for a lithium ion secondary battery satisfies the above, it becomes possible to produce a lithium ion secondary battery with excellent input characteristics and life characteristics.

The input characteristics are improved by the average particle diameter (D50) of the spherical natural graphite particle and the composite particle being 12 μm or less and the linseed oil absorption of the spherical natural graphite particle and the composite particle being 45 mL/100 g or more. Although the reason is not clear, by satisfying the above, the electrode density increases when the negative electrode material for a lithium ion secondary battery is applied to a current collector, and the pressing pressure required to obtain the desired electrode density in the negative electrode for a lithium ion secondary battery tends to be reduced. As a result, a planar orientation of the negative electrode material for a lithium ion secondary battery tends to be low, and lithium ions tend to be stored more easily during charging and discharging, improving the input characteristics.

In addition, in a case in which the average particle diameter (D50) of the spherical natural graphite particle and the composite particle is 12 μm or less, a deterioration of the life characteristics is suppressed by setting the linseed oil absorption to 65 mL/100 g or less.

In addition, by setting the linseed oil absorption to 45 mL/100 g or more, an adhesion between the spherical natural graphite particles and composite particles, which are the negative electrode active material, and the current collector tends to be improved. Therefore, by using the negative electrode material for a lithium ion secondary battery in the present embodiment, even when the spherical natural graphite particle and the composite particle repeatedly expand and shrink due to charging and discharging, the adhesion between the spherical natural graphite particle and the composite particle and the current collector is maintained, and it tends to be possible to produce a lithium ion secondary battery with excellent cycle characteristics.

Furthermore, in the negative electrode material for a lithium ion secondary battery, since the adhesion between the spherical natural graphite particles and the composite particles and the current collector is high, an amount of binder required in producing the negative electrode can be reduced, and lithium ion secondary battery with excellent energy density tend to be produced at low cost.

The spherical natural graphite particle and the composite particle in the first embodiment have a linseed oil absorption of 45 mL/100 g or more, preferably 46 mL/100 g or more, and may be 48 mL/100 g or more.

Furthermore, the spherical natural graphite particle and the composite particle in the first embodiment have a linseed oil absorption of 65 mL/100 g or less, and from the viewpoint of further improving the input characteristics and cycle characteristics of the lithium ion secondary battery, the linseed oil absorption is preferably 55 mL/100 g or less, more preferably 54 mL/100 g or less, even more preferably 53 mL/100 g or less, and particularly preferably 50 mL/100 g or less.

The linseed oil absorption of the spherical natural graphite particle and the composite particle tends to increase in a case in which (1) the average particle diameter is reduced, (2) a tap density of the particles is reduced, or (3) a specific surface area of the particles is increased, or the like. The reason for (1) is thought to be that a number of particles present increases even with the same mass, and the volume between particles, into which linseed oil is absorbed, increases. The reason for (2) is thought to be that a number of voids within the particles increases. The reason for (3) is thought to be that a concavity and convexity of the particle surface increases. By balancing these factors, the linseed oil absorption of the spherical natural graphite particle and the composite particle may be adjusted to within the above range.

The macropore volume of the spherical natural graphite particle and the composite particle in the first embodiment is not particularly limited, and may be 0.59 mL/g or more, 0.595 mL/g or more, or 0.60 mL/g or more.

The macropore volume of the spherical natural graphite particle and the composite particle in the first embodiment may be 0.80 mL/g or less, 0.78 mL/g or less, 0.75 mL/g or less, 0.70 mL/g or less, or 0.65 mL/g or less, from the viewpoint of further improving the life characteristics of the lithium ion secondary battery.

The macropore volume of the spherical natural graphite particle and the composite particle tends to increase in a case in which (1) the average particle diameter is reduced, (2) a tap density of the particles is decreased, or (3) a specific surface area of the particle is increased. The reason for (1) is thought to be that a number of particles present increases even with the same mass, and the volume between particles, into which mercury used for measuring the macropore volume is absorbed, increases. The reason for (2) is thought to be that a number of voids within the particles increases. The reason for (3) is thought to be that a concavity and convexity of the particle surface increases. By balancing these factors, the macropore volume of the spherical natural graphite particle and the composite particle may be adjusted to within the above range.

A micropore volume of the spherical natural graphite particle and the composite particle in the first embodiment is not particularly limited, and from the viewpoint of further improving the input characteristics of the lithium ion secondary battery, it may be 1.15×10⁻³ cm or more, 1.19×10⁻³ cm³ or more, 1.20×10⁻³ cm³ or more, or 1.25×10⁻³ cm³ or more.

From the viewpoint of further improving the life characteristics of the lithium ion secondary battery, the micropore volume of the spherical natural graphite particle and the composite particle in the first embodiment may be 1.40×10⁻³ cm³ or less, 1.35×10⁻³ cm³ or less, or 1.30×10⁻³ cm³ or less.

The micropore volume of the spherical natural graphite particle and the composite particle tends to increase in a case in which (1) a specific surface area of the particles is increased, or (2) in a case in which at least a portion of a surface of the spherical natural graphite particle and the composite particle is coated with a carbon material, the sintering temperature during coating is lowered. The reason for (1) is thought to be that a concavity and convexity of the particle surface increases. The cause of (2) is thought to be decreases in density and sintering tightness due to insufficient decomposition of the coating material. By balancing these factors, the micropore volume of the spherical natural graphite particle and the composite particle can be adjusted to within the above range. By balancing these factors, the micropore volume of the spherical natural graphite particle and the composite particle may be adjusted to within the above range.

A specific surface area of the spherical natural graphite particle and the composite particle determined by nitrogen adsorption measurement at 77K (hereinafter also referred to as “N₂ specific surface area”) is preferably from 2 m²/g to 8 m²/g, more preferably from 2.5 m²/g to 7 m²/g, and even more preferably from 3 m²/g to 6 m²/g. In a case in which the N₂ specific surface area is within the above range, an excellent balance between the input characteristics and the initial charge/discharge efficiency in the lithium ion secondary battery tends to be obtained. The N₂ specific surface area is determined by the BET method using the adsorption isotherm obtained by nitrogen adsorption measurement at 77K.

An average interplanar distance d₀₀₂ of the spherical natural graphite particle and the composite particle is preferably from 0.334 nm to 0.338 nm as determined by the X-ray diffraction method. In a case in which the average interplanar distance d₀₀₂ is 0.338 nm or less, the initial charge/discharge efficiency and energy density in the lithium ion secondary battery tend to be excellent.

The average interplanar distance d₀₀₂ of the spherical natural graphite particle and the composite particle tends to be smaller, for example, by increasing a temperature of the heat treatment when preparing the negative electrode material. Therefore, the average interplanar distance d₀₀₂ of the carbon material may be controlled by adjusting the temperature of the heat treatment when preparing the negative electrode material.

In the present disclosure, the average interplanar distance d₀₀₂ is calculated using Bragg's equation using a diffraction peak that appears at a diffraction angle of 2θ=from 24° to 27° corresponding to the carbon 002 plane from a diffraction profile obtained by irradiating a sample with X-rays (CuKα rays) and measuring the diffraction rays with a goniometer.

Specifically, the measurement sample is filled into the recessed portion of a sample holder made of quartz and set on the measurement stage, and the measurement is performed under the following measurement conditions using a wide-angle X-ray diffraction device (manufactured by Rigaku Corporation).
Radiation source: CuKα radiation (wavelength=0.15418 nm)
Output: 40 kV, 20 mA
Sampling width: 0.010°
Scanning range: from 10° to 35°
Scanning speed: 0.5°/min

An R value of the spherical natural graphite particle and the composite particle measured by Raman spectroscopy is preferably from 0.1 to 1.0, more preferably from 0.2 to 0.8, and even more preferably from 0.3 to 0.7. In a case in which the R value is 0.1 or more, there is a sufficient amount of graphite lattice defects used for the store and release of lithium ions, and a deterioration of input characteristics tends to be suppressed. In a case in which the R value is 1.0 or less, a decomposition reaction of the electrolyte is sufficiently suppressed, and a deterioration of the initial efficiency tends to be suppressed.

The R value is defined as the intensity ratio (Id/Ig) of a maximum peak intensity Ig around 1580 cm⁻¹ to a maximum peak intensity Id around 1360 cm⁻¹ in the Raman spectrum obtained in the Raman spectroscopy measurement.

In the present disclosure, Raman spectroscopy measurement is performed using a laser Raman spectrophotometer, by irradiating an argon laser beam onto a sample plate on which a measurement sample is set so as to be flat. As a laser Raman spectrophotometer, for example, NRS-1000 manufactured by JASCO Corporation may be used. The measurement conditions are as follows.
Wavelength of argon laser beam: 532 nm
Wavenumber resolution: 2.56 cm⁻¹
Measurement range: from 1180 cm⁻¹ to 1730 cm⁻¹
Peak research: background removal

At least a portion of a surface of the spherical natural graphite particle and the composite particle may be coated with a carbon material. Presence of the carbon material on the surface of the spherical natural graphite particle or the composite particle may be confirmed by observation with a transmission electron microscope.

“At least a portion of a surface of the spherical natural graphite particle and the composite particle is coated with a carbon material” means that, in a case in which the negative electrode material contains only one of the spherical natural graphite particle or the composite particle, at least a portion of the surface of the spherical natural graphite particles is coated with a carbon material, or at least a portion of the surface of the composite particles is coated with a carbon material. And it means that at least a part of particle of a spherical natural graphite particle and the composite particle contained in the negative electrode material are coated with a carbon material. It is preferable that half or more of the particles of the spherical natural graphite particle and the composite particle contained in the negative electrode material have a portion coated with a carbon material, more preferably that 90% or more of the particles have a portion coated with a carbon material, and even more preferably that 95% or more of the particles have a portion coated with a carbon material.

From the viewpoint of improving the input characteristics of the lithium ion secondary battery, it is preferable that the carbon material that is the coating material has a lower crystallinity than the spherical natural graphite particle and the composite particle, and it is more preferable that the carbon material is amorphous carbon. Specifically, the carbon material is preferably at least one selected from the group consisting of a carbonaceous substance obtained from organic compounds (hereinafter also referred to as a precursor of carbonaceous material) that can be converted into carbonaceous materials by heat treatment, and a carbonaceous particle. The carbonaceous material may be used singly, or in a combination of two or more kinds thereof.

The precursor of carbon material is not particularly limited, and examples thereof include a pitch and an organic polymer compound. Examples of pitch include an ethylene heavy end pitch, a crude oil pitch, a coal tar pitch, an asphalt decomposition pitch, a pitch produced by pyrolyzing polyvinyl chloride, and a pitch produced by polymerizing naphthalene in the presence of a super strong acid. Examples of the organic polymer compound include a thermoplastic resin such as polyvinyl chloride, polyvinyl alcohol, polyvinyl acetate, and polyvinyl butyral, and a natural substance such as a starch and a cellulose.

The carbonaceous particle used as the carbon material is not particularly limited, and examples thereof include a particle of an acetylene black, an oil furnace black, a ketjen black, a channel black, a thermal black, soil graphite, or the like.

A method of coating with the carbon material includes heat-treating a mixture containing the spherical natural graphite particle or the composite particle as the core and the precursor of the carbon material.

From the viewpoint of improving the input characteristics of the lithium ion secondary battery, a temperature at which the mixture is heat-treated is preferably from 800° C. to 1500° C., more preferably from 900° C. to 1300° C., and even more preferably from 1050° C. to 1250° C. The temperature at which the mixture is heat-treated may be constant from the start to the end of the heat treatment, or may not be constant.

### Second Embodiment

A negative electrode material in the second embodiment includes at least one selected from the group consisting of a spherical natural graphite particle and a composite particle which is aggregate of the spherical natural graphite particles, in which the spherical natural graphite particle and the composite particle have an average particle diameter (D50) of 12 μm or less and an integrated pore volume in a pore size range of from 0.003 μm to 90 μm of from 0.59 mL/g to 0.80 mL/g.

In a case in which the negative electrode material for a lithium ion secondary battery satisfies the above, it becomes possible to produce a lithium ion secondary battery with excellent input characteristics and life characteristics.

In a case in which the spherical natural graphite particle and the composite particle have an average particle diameter (D50) of 12 μm or less, a number of sites used for storing lithium ions is increased by having the macropore volume thereof of 0.59 mL/g or more, thereby improving the input characteristics. Furthermore, in a case in which the average particle diameter (D50) of the spherical natural graphite particle and the composite particle is 12 μm or less, the life characteristics are maintained by having the macropore volume of the spherical natural graphite particle and the composite particle of 0.80 mL/100 g or less.

The spherical natural graphite particle and the composite particle in the second embodiment have a macropore volume of 0.59 mL/g or more, preferably 0.595 mL/g or more, and more preferably 0.60 mL/g or more.

The spherical natural graphite particle and the composite particle in the second embodiment have a macropore volume of 0.80 mL/g or less, preferably 0.78 mL/g or less, more preferably 0.75 mL/g or less, and may be 0.70 mL/g or less, or may be 0.65 mL/g or less

A linseed oil absorption of the spherical natural graphite particle and the composite particle in the second embodiment is not particularly limited, and may be 45 mL/100 g or more, 46 mL/100 g or more, or 48 mL/100 g or more.

From the viewpoint of further improving the input characteristics and cycle characteristics of the lithium ion secondary battery, the linseed oil absorption of the spherical natural graphite particle and the composite particle in the second embodiment may be 65 mL/100 g or less, 63 mL/100 g or less, 60 mL/100 g or less, 55 mL/100 g or less, 54 mL/100 g or less, 53 mL/100 g or less, or 50 mL/100 g or less.

A micropore volume of the spherical natural graphite particle and the composite particle in the second embodiment is not particularly limited, and from the viewpoint of further improving the input characteristics of the lithium ion secondary battery, it may be 1.15×10⁻³ cm³/g or more, 1.19×10⁻³ cm³/g or more, 1.20×10⁻³ cm³/g or more, or 1.25×10⁻³ cm³/g or more.

From the viewpoint of further improving the life characteristics of the lithium ion secondary battery, the micropore volume of the spherical natural graphite particle and the composite particle in the second embodiment may be 1.40×10⁻³ cm³/g or less, 1.35×10⁻³ cm³/g or less, or 1.30×10⁻³ cm³/g or less.

Other physical properties such as the average interplanar distance d₀₀₂ of the spherical natural graphite particle and the composite particle in the second embodiment, and other items such as coating, are the same as those in the first embodiment.

### <Method of Producing Negative Electrode Material for Lithium Ion Secondary Battery>

A method of producing the negative electrode material for a lithium ion secondary battery in the present disclosure includes preparing a rubber mold that contains graphite particles; and dry-pressuring the rubber mold from the outside isotropically. By performing the pressurization in a dry manner without using a medium such as water as the surrounding environment, the negative electrode material for a lithium ion secondary battery containing a composite particle may be easily manufactured, and Labor savings may be achieved.

The rubber mold is not particularly limited as long as it can withstand external pressure. Pressure is propagated isotropically through the rubber mold to the graphite particles packed inside the rubber mold. Isotropic pressurization tends to produce the negative electrode material for a lithium ion secondary battery containing a composite particle with little anisotropy.

In addition, by isotropically pressing the graphite particles, graphite particles with a relatively small particle size tend to aggregate easily. This suppresses a dilatancy of a slurry-like negative electrode material composition used for forming a negative electrode material layer, thereby providing excellent workability in application.

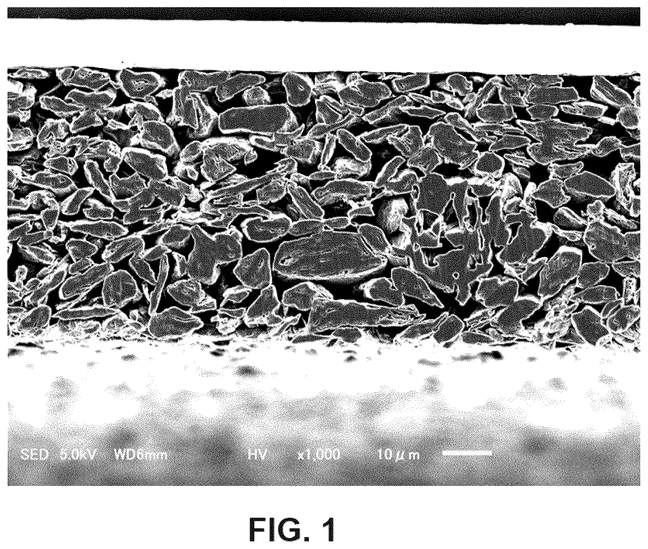

FIG. 1 shows an electron microscope photograph of a cross section of a negative electrode material obtained by the producing method in the present disclosure. The negative electrode material in FIG. 1 is a composite particle in which spherical natural graphite particles are agglomerated. The negative electrode material obtained by the producing method in the present disclosure may contain both a non-agglomerated spherical natural graphite particle and an agglomerated composite particle.

A method of dry-pressuring may be any method, and examples thereof include a circumferential/axial pressure method and a circumferential pressure method, depending on the direction in which pressure acts.

The pressure is preferably adjusted appropriately depending on a type of the graphite particle, a size of the rubber mold, and the like, and may be, for example, from 10 MPa to 500 MPa.

The graphite particle used in the method of producing the negative electrode material for a lithium ion secondary battery in the present disclosure may be any of an artificial graphite particle, a natural graphite particle, a graphitized mesophase carbon particle, a graphitized carbon fiber, or the like. The natural graphite particle may be a natural graphite particle in the form of flakes, scales, or plates, or may be a spherical natural graphite particle obtained by spheroidizing these natural graphite particles.

The method of producing the negative electrode material for a lithium ion secondary battery in the present disclosure may be used as the method of producing the negative electrode material for a lithium ion secondary battery in the first or second embodiment described above. In this case, a spherical natural graphite particle obtained by spheroidizing natural graphite particle is used as the graphite particle.

### <Negative Electrode for Lithium Ion Secondary Battery>

A negative electrode for a lithium ion secondary battery in the present disclosure includes a negative electrode material layer containing the negative electrode material for a lithium ion secondary battery in the present disclosure described above, and a current collector. The negative electrode for a lithium ion secondary battery may contain other components as necessary in addition to the negative electrode material layer containing the negative electrode material in the present disclosure and a current collector.

The negative electrode for a lithium ion secondary battery may be produced, for example, by kneading the negative electrode material and a binder with a solvent to prepare a slurry-like negative electrode material composition, which is then applied to a current collector to form a negative electrode material layer, or by forming the negative electrode material composition into a sheet, pellet, or other shape and integrating it with a current collector. Kneading may be performed using a dispersing device such as a stirrer, ball mill, super sand mill, or pressure kneader.

The binder used in preparing the negative electrode material composition is not particularly limited. Examples of the binder include a styrene-butadiene copolymer, a polymer of an ethylenically unsaturated carboxylic acid ester such as methyl acrylate, methyl methacrylate, ethyl acrylate, ethyl methacrylate, butyl acrylate, butyl methacrylate, acrylonitrile, methacrylonitrile, hydroxyethyl acrylate, and hydroxyethyl methacrylate, a polymer of an ethylenically unsaturated carboxylic acid such as acrylic acid, methacrylic acid, itaconic acid, fumaric acid, and maleic acid, and a polymeric compound having high ionic conductivity such as polyvinylidene fluoride, polyethylene oxide, polyepichlorohydrin, polyphosphazene, and polyacrylonitrile. In a case in which the negative electrode material composition contains a binder, a content of the binder is not particularly limited. The content of the binder may be, for example, from 0.5 parts by mass to 20 parts by mass with respect to 100 parts by mass of a total of the negative electrode material and the binder.

The solvent is not particularly limited as long as it can dissolve or disperse the binder. Specific examples thereof include an organic solvent such as N-methyl-2-pyrrolidone, N,N-dimethylacetamide, N,N-dimethylformamide, and γ-butyrolactone. A content of the solvent used is not particularly limited as long as it can make the negative electrode material composition into a desired state such as a paste. The content of the solvent used is preferably, for example, from 60 parts by mass or more and less than 150 parts by mass with respect to 100 parts by mass of the negative electrode material.

The negative electrode material composition may contain a thickener. Examples of the thickener include carboxymethylcellulose or a salt thereof, methylcellulose, hydroxymethylcellulose, hydroxyethylcellulose, ethylcellulose, polyvinyl alcohol, polyacrylic acid or a salt thereof, alginic acid or a salt thereof, an oxidized starch, a phosphorylated starch, and casein. In a case in which the negative electrode material composition contains a thickener, a content thereof is not particularly limited. The content of the thickener may be, for example, from 0.1 parts by mass to 5 parts by mass with respect to 100 parts by mass of the negative electrode material.

The negative electrode material composition may contain a conductive auxiliary material. Examples of the conductive auxiliary material include a carbon material such as an artificial graphite and a carbon black (acetylene black, thermal black, furnace black, and the like), an oxide that exhibits conductivity, and a nitride that exhibits conductivity. In a case in which the negative electrode material composition contains the conductive auxiliary material, a content thereof is not particularly limited. The content of the conductive auxiliary material may be, for example, from 0.5 parts by mass to 15 parts by mass with respect to 100 parts by mass of the negative electrode material.

A material of the current collector is not particularly limited and may be selected from aluminum, copper, nickel, titanium, stainless steel, and the like. A shape of the current collector is not particularly limited and may be selected from foil, perforated foil, mesh, and the like. In addition, a porous material such as porous metal (foamed metal) and carbon paper may also be used as the current collector.

In a case in which the negative electrode material composition is applied to the current collector to form the negative electrode material layer, a method thereof is not particularly limited, and a known method such as metal mask printing, electrostatic painting, dip coating, spray coating, roll coating, doctor blade, comma coating, gravure coating, and screen printing can be used. After the negative electrode material composition is applied to the current collector, the solvent contained in the negative electrode material composition is removed by drying. The drying may be performed, for example, using a hot air dryer, an infrared dryer, or a combination of these devices. A rolling process may be performed as necessary. The rolling process may be performed using a method such as a flat plate press or a calendar roll.

In a case in which the negative electrode material composition molded into a shape such as a sheet or pellet is integrated with the current collector to form the negative electrode material layer, the integration method is not particularly limited. For example, it can be performed using a roll, a flat plate press, or a combination of these measures. The pressure during integration is preferably, for example, from 1 MPa to 200 MPa.

### <Lithium-Ion Secondary Battery>

A lithium-ion secondary battery in the present disclosure includes the negative electrode for a lithium-ion secondary battery in the present disclosure described above (hereinafter also simply referred to as the “negative electrode”), a positive electrode, and an electrolyte.

The positive electrode may be obtained by forming a positive electrode material layer on a current collector in the same manner as the negative electrode described above. As the current collector, a metal or alloy such as aluminum, titanium, or stainless steel in a foil, perforated foil, mesh, or other form may be used.

The positive electrode material used to form the positive electrode material layer is not particularly limited. For example, a metal compound (a metal oxide, a metal sulfide, and the like.) that can dope or intercalate lithium ions and a conductive polymer material can be used. More specific examples thereof include lithium cobalt oxide (LiCoO₂), lithium nickel oxide (LiNiO₂), lithium manganese oxide (LiMnO₂), a their composite oxide (LiCoₓNi_{y}Mn_{z}O₂, x+y+z=1), a composite oxide containing an additional element M′ (LiCoₐNi_{b}Mn_{c}M′_{d}O₂, a+b+c+d=1, M′: Al, Mg, Ti, Zr, or Ge), a spinel-type lithium manganese oxide (LiMn₂O₄), a lithium vanadium compound, V₂O₅, V₆O₁₃, VO₂, MnO₂, TiO₂, MoV₂O₈, TiS₂, V₂S₅, VS₂, MoS₂, MoS₃, Cr₃O₈, Cr₂O₅, a lithium-containing compound such as an olivine-type LiMPO₄ (M: Co, Ni, Mn, Fe), a conductive polymer such as a polyacetylene, a polyaniline, a polypyrrole, a polythiophene, a polyacene, a porous carbon, and the like. The positive electrode material may be used singly, or in a combination of two or more kinds thereof.

The electrolyte is not particularly limited, and for example, a solution in which a lithium salt is dissolved as an electrolyte in a non-aqueous solvent (a so-called organic electrolyte) may be used.

Examples of the lithium salts include LiClO₄, LiPF₆, LiAsF₆, LiBF₄, and LiSO₃CF₃. The lithium salt may be used singly, or in a combination of two or more kinds thereof.

Examples of the non-aqueous solvent include ethylene carbonate, fluoroethylene carbonate, chloroethylene carbonate, propylene carbonate, butylene carbonate, vinylene carbonate, cyclopentanone, cyclohexylbenzene, sulfolane, propane sultone, 3-methylsulfolane, 2,4-dimethylsulfolane, 3-methyl-1,3-oxazolidin-2-one, γ-butyrolactone, dimethyl carbonate, diethyl carbonate, ethyl methyl carbonate, methyl propyl carbonate, butyl methyl carbonate, ethyl propyl carbonate, butyl ethyl carbonate, dipropyl carbonate, 1,2-dimethoxyethane, tetrahydrofuran, 2-methyltetrahydrofuran, 1,3-dioxolane, methyl acetate, ethyl acetate, trimethyl phosphate, and triethyl phosphate. The non-aqueous solvent may be used singly, or in a combination of two or more kinds thereof.

A state of the positive electrode and the negative electrode in the lithium ion secondary battery is not particularly limited. For example, the positive electrode and the negative electrode and, if necessary, a separator disposed between the positive electrode and the negative electrode may be wound in a spiral shape, or may be laminated in a flat plate shape.

The separator is not particularly limited, and may be, for example, a nonwoven fabric, a cloth, or a microporous film, which are made of a resin, or a combination of these. Examples of the resin include those containing a polyolefin such as polyethylene and polypropylene as the main component. In a case in which the positive electrode and the negative electrode are not in direct contact with each other due to the structure of the lithium ion secondary battery, a separator may not be used.

A shape of the lithium ion secondary battery is not particularly limited. Examples thereof include a laminated battery, a paper battery, a button battery, a coin battery, a stacked battery, a cylindrical battery, and a square battery.

The lithium ion secondary battery in the present disclosure has excellent output characteristics, and is therefore suitable as a large-capacity lithium ion secondary battery for use in electric vehicles, power tools, power storage devices, and the like. In particular, the lithium-ion secondary battery is suitable for use in electric vehicles (EVs), hybrid electric vehicles (HEVs), plug-in hybrid electric vehicles (PHEVs), and the like, which require large current charging and discharging in order to improve acceleration performance and brake regeneration performance.

### EXAMPLES

The present invention will be described in detail below with reference to the following examples, but the present invention is not limited to these examples.

### (Preparation of Negative Electrode Material)

### Example 1

Spherical natural graphite particles with an average particle diameter (D50) of 8 μm were subjected to isotropic dry pressure treatment. The spherical natural graphite particles were filled into a rubber mold and pressure was applied from all sides at 100 MPa. An average particle diameter (D50) of the spherical natural graphite particles after pressure treatment was 10.7 μm. A part of the spherical natural graphite particles after pressure treatment had aggregated to form composite particles.

100 parts by mass of the spherical natural graphite particles after pressure treatment were mixed with 3.2 parts by mass of a coal tar pitch (softening point 90° C., residual carbon rate (carbonization rate) 50% by mass). The mixture was then heated to 1050° C. at a heating rate of 250° C./hour under nitrogen flow, and held at 1050° C. (the calcination temperature) for 1 hour to obtain carbon layer-coated graphite particles (carbon material). The obtained carbon layer-coated carbon particles were crushed using a cutter mill and then sieved through a 350 mesh sieve, and the undersieve portion was used as the negative electrode material.

An average particle diameter (D50), a micropore volume, a linseed oil absorption, a macropore volume, and a specific surface area of the obtained negative electrode material were measured using the following methods. The physical properties are shown in Table 1.

### [Measurement of Average Particle Diameter (D50)]

A solution of the negative electrode material sample dispersed in purified water together with 0.2 mass % of a surfactant (product name: Liponol T/15, manufactured by Lion Corporation) was placed in the sample water tank of a laser diffraction particle size distribution analyzer (SALD-3000J, manufactured by Shimadzu Corporation). Next, the solution was circulated with a pump while applying ultrasonic waves (pump flow rate was 65% of the maximum value), and the amount of water was adjusted so that the absorbance was from 0.10 to 0.15. The particle size at 50% cumulative volume (D50) of the obtained particle size distribution was taken as the average particle diameter. The results are shown in Table 1.

[Micropore volume]

A micropore volume of the negative electrode material was measured using the method described above. The results are shown in Table 1.

### [Linseed Oil Absorption (Oil Absorption)]

A linseed oil absorption of the negative electrode material was measured using the method described above. The results are shown in Table 1.

### [Macropore Volume]

A macropore volume of the negative electrode material was measured using the method described above. The results are shown in Table 1.

### [Measurement of Specific Surface Area]

For the negative electrode material samples, a nitrogen adsorption was measured at liquid nitrogen temperature (77K) using a single-point method using a high-speed specific surface area/pore distribution measuring device (Flow Sorb III, manufactured by Shimadzu Corporation), and a specific surface area was calculated using the BET method. The results are shown in Table 1.

### Example 2

A negative electrode material was produced in the same manner as in Example 1, except that the spherical natural graphite particles used as the raw material were changed to those with an average particle diameter (D50) of 9.8 μm, and that the dry pressure treatment was not performed. The physical properties of the produced negative electrode material were measured in the same manner as in Example 1. The physical properties are shown in Table 1.

### Example 3

A negative electrode material was produced in the same manner as in Example 1, except that the spherical natural graphite particles used as the raw material were changed to those with an average particle diameter (D50) of 8.7 μm, and that the dry pressure treatment was not performed. The physical properties of the produced negative electrode material were measured in the same manner as in Example 1. The physical properties are shown in Table 1.

### Example 4

A negative electrode material was produced in the same manner as in Example 1, except that the spherical natural graphite particles used as the raw material were changed to those with an average particle diameter (D50) of 8.8 μm and a lower linseed oil absorption, and that the dry pressure treatment was not performed. The physical properties of the produced negative electrode material were measured in the same manner as in Example 1. The physical properties are shown in Table 1.

### Example 5

A negative electrode material was produced in the same manner as in Example 1, except that the spherical natural graphite particles used as the raw material were changed to those with an average particle diameter (D50) of 8.8 μm and an even lower linseed oil absorption, and that the dry pressure treatment was not performed. The physical properties of the produced negative electrode material were measured in the same manner as in Example 1. The physical properties are shown in Table 1.

### Example 6

A negative electrode material was produced in the same manner as in Example 1, except that the spherical natural graphite particles used as the raw material were changed to those with an average particle diameter (D50) of 7.9 μm, and that the dry pressure treatment was not performed. The physical properties of the produced negative electrode material were measured in the same manner as in Example 1. The physical properties are shown in Table 1.

### Comparative Example 1

A negative electrode material was produced in the same manner as in Example 1, except that the spherical natural graphite particles used as the raw material were changed to those with an average particle diameter (D50) of 10.4 μm, and that the dry pressure treatment was not performed. The physical properties of the produced negative electrode material were measured in the same manner as in Example 1. The physical properties are shown in Table 1.

### (Production of Lithium Ion Secondary Battery for Input Characteristic Evaluation)

Using the negative electrode material prepared in each example, lithium ion secondary batteries for input characteristic evaluation were produced according to the following procedure.

First, an aqueous solution (CMC concentration: 2% by mass) of CMC (carboxymethyl cellulose, manufactured by Daicel Fine Chem Co., Ltd., product number 2200) was added as a thickener to 98 parts by mass of the negative electrode material so that a solid content of CMC was 1 part by mass, and the mixture was kneaded for 10 minutes. Next, purified water was added so that a total solid content of the negative electrode material and CMC was from 40% by mass to 50% by mass, and the mixture was kneaded for 10 minutes. Next, an aqueous dispersion (SBR concentration: 40% by mass) of SBR (BM400-B, manufactured by Zeon Corporation), which is a styrene butadiene copolymer rubber, was added as a binder so that a solid content of SBR was 1 part by mass, and the mixture was mixed for 10 minutes to prepare a paste-like negative electrode material composition. Next, the negative electrode material composition was applied to electrolytic copper foil having a thickness of 11 μm using a comma coater with an adjusted clearance so that a coating amount per unit area was 5.9 mg/cm², to form a negative electrode material layer. After that, an electrode density was adjusted to 1.2 g/cm³ using a hand press. The electrolytic copper foil, on which the negative electrode material layer was formed, was punched into a disk shape with a diameter of 16 mm to prepare a sample electrode (negative electrode).

The prepared sample electrode (negative electrode), a separator, and a counter electrode (positive electrode) were placed in a coin-type battery container in this order, and an electrolyte was injected thereto to produce a coin-type lithium-ion secondary battery. The electrolyte used was a mixed solvent of ethylene carbonate (EC) and ethyl methyl carbonate (EMC) (volume ratio of EC to EMC was 3:7), to which 0.5 mass % of vinylene carbonate (VC) was added relative to a total amount of the mixed solution, and LiPF₆ was dissolved to a concentration of 1 mol/L. LiNi_{0.5}Mn_{0.3}Co_{0.2}O₂ (NMC532) was used as the counter electrode (positive electrode). A microporous polyethylene membrane having a thickness of 20 μm was used as the separator. The input characteristics of the lithium ion secondary battery were evaluated using the following method.

### (Evaluation of Input Characteristics)

A direct current resistance (DCR) of the lithium ion secondary battery was measured to determine the input characteristics of this battery. Specifically, the following was done.

The lithium-ion secondary battery was placed in a thermostatic chamber set at 25° C. and charged at a constant current/constant voltage (CC/CV) of 0.2C, 4.2V, and a final current of 0.02C, followed by three cycles of constant current (CC) discharge at 0.2C to 2.5V. Next, the battery was then charged at a constant current of 0.2C to an SOC of 60%.

Meanwhile, the lithium-ion secondary battery was also placed in a thermostatic chamber set at −10° C. and charged at a constant current of 0.2C, 0.5C and 1C for 10 seconds each, measuring the voltage drop (ΔV) at each constant current, and measuring the direct current resistance (DCR) using the formula below. The results are shown in Table 1. A lower direct current resistance (DCR) value indicates better input characteristics.

$$DCR [ \text{} Ω ] = \{ ( 0.5 C voltage drop Δ V - 0.2 C voltage drop Δ V ) +$$

$$( 1 C voltage drop Δ V - 0.5 C voltage drop Δ V ) \} / 0.8$$

Table 1 shows the DC resistance (DCR) of the lithium-ion secondary battery using the negative electrode material of each example, when the DC resistance (DCR) of the lithium-ion secondary battery using the negative electrode material of Comparative Example 1 is set to 100. The lower the DC resistance (DCR) value, the better the life characteristics.

### (Evaluation of Storage Characteristics)

The lithium ion secondary battery produced was subjected to charge/discharge measurements to determine storage characteristics of the battery. Specifically, the following was done.

The lithium ion secondary battery was placed in a thermostatic chamber set at 25° C., and charged at a constant current/constant voltage (CC/CV) of 0.2C, 4.2V, and a final current of 0.02C, followed by three cycles of constant current (CC) discharge at 0.2C to 2.5V. Next, constant current charging was performed at a current value of 0.2C to an SOC of 100%.

Meanwhile, the lithium ion secondary battery was also placed in a thermostatic chamber set at 60° C. and left for 7 days, and then placed in a thermostatic chamber set at 25° C. and discharged to 2.5V at a constant current (CC) of 0.2C. Storage characteristics were measured using the following formula. The results are shown in Table 1. The higher the value of the storage properties, the less likely it is to deteriorate and the better the storage properties.

$$Storage characteristics = ( discharge capacity after 7 days storage , at 60 ° C . at SOC of 100 \% ) / ( discharge capacity at 3 rd cycle )$$

Table 1 shows the storage characteristics of the lithium-ion secondary battery using the negative electrode material of each example, when the storage characteristics of the lithium-ion secondary battery using the negative electrode material of Comparative Example 1 is set to 100. The higher the value of the storage characteristics, the less likely it is to deteriorate, and the better the storage characteristics.

### (Evaluation of Hand Press Pressure)

In the production of the above lithium-ion secondary battery, the hand press pressure required to make the electrode density of the negative electrode 1.2 g/cm³ is shown in Table 1 for the lithium-ion secondary battery using the negative electrode material of each example, when the hand press pressure of the lithium-ion secondary battery using the negative electrode material of Comparative Example 1 is set to 100. Higher values of hand press pressure indicate more force required to achieve the same electrode density, which increases the load on the electrode.

TABLE 1

| | | | | | | | Comparative |
|---|---|---|---|---|---|---|---|
| Item | Example 1 | Example 2 | Example 3 | Example 4 | Example 5 | Example 6 | Example 1 |
| Average particle diameter (D50) [μm] | 10.7 | 9.8 | 8.7 | 8.8 | 9.0 | 8.2 | 10.4 |
| Linseed oil absorption [mL/100 g] | 50 | 49 | 55 | 48 | 46 | 63 | 43 |
| Macropore volume [mL/g] | 0.61 | 0.61 | 0.71 | 0.61 | 0.60 | 0.75 | 0.58 |
| Micropore volume [×10⁻³ cm³/g] | 1.27 | 1.15 | 1.29 | 1.21 | 1.20 | 1.25 | 1.18 |
| Specific surface area [m²/g] | 4.5 | 4.1 | 4.5 | 4.2 | 4.2 | 4.4 | 4.3 |
| Input characteristics [index] | 95 | 97 | 95 | 95 | 95 | 93 | 100 |
| Storage characteristics [index] | 97 | 98 | 98 | 99 | 99 | 96 | 100 |
| Hand press pressure required to achieve | 103 | 102 | 103 | 95 | 95 | 113 | 100 |
| the same electrode density [index] | | | | | | | |

1. A negative electrode material for a lithium ion secondary battery, the negative electrode material comprising at least one selected from the group consisting of a spherical natural graphite particle and a composite particle which is an aggregate of the spherical natural graphite particles,
wherein the spherical natural graphite particle and the composite particle have an average particle diameter (D50) of 12 μm or less and a linseed oil absorption of from 45 mL/100 g to 65 mL/100 g.

2. The negative electrode material for a lithium ion secondary battery according to claim 1, wherein the spherical natural graphite particle and the composite particle have an integrated pore volume in a pore size range of from 0.003 μm to 90 μm of from 0.59 mL/g to 0.80 mL/g.

3. A negative electrode material for a lithium ion secondary battery, the negative electrode material comprising at least one selected from the group consisting of a spherical natural graphite particle and a composite particle which is aggregate of the spherical natural graphite particles,
wherein the spherical natural graphite particle and the composite particle have an average particle diameter (D50) of 12 μm or less and an integrated pore volume in a pore size range of from 0.003 μm to 90 μm of from 0.59 mL/g to 0.80 mL/g.

4. A negative electrode material for a lithium ion secondary battery according to claim 1, wherein the spherical natural graphite particle and the composite particle have an average particle diameter (D50) of 12 μm or less and an integrated pore volume in a pore size range of 2 nm or less of from 1.15×10⁻³ cm³/g to 1.40×10⁻³ cm³/g.

5. The negative electrode material for a lithium ion secondary battery according to claim 1, wherein at least a portion of a surface of the spherical natural graphite particle and the composite particle is coated with a carbon material.

6. A method of producing a negative electrode material for a lithium ion secondary battery, the method comprising:
preparing a rubber mold that contains graphite particles; and
dry-pressuring the rubber mold from the outside isotropically.

7. The method of producing a negative electrode material for lithium ion secondary battery according to claim 6, the method further comprising heat-treating a mixture containing the graphite particles after the dry-pressuring and a carbon material precursor.

8. A method of producing a negative electrode material for a lithium ion secondary battery according to claim 1:
preparing a rubber mold that contains graphite particles; and
dry-pressuring the rubber mold from the outside isotropically.

9. A negative electrode for a lithium ion secondary battery, the negative electrode comprising a negative electrode material layer containing the negative electrode material for a lithium ion secondary battery according to claim 1, and a current collector.

10. A lithium ion secondary battery comprising the negative electrode for a lithium ion secondary battery according to claim 9, a positive electrode, and an electrolyte.
